(19) United States
(12) Patent Application Publication
(10) Pub. No.: US 2024/0123688 A1
(43) Pub. Date: Apr. 18, 2024

(54) METHOD AND DEVICE FOR CONTROLLING A LITHOGRAPHY-BASED ADDITIVE MANUFACTURING DEVICE

(71) Applicant: TECHNISCHE UNIVERSITÄT WIEN, Vienna (AT)

(72) Inventors: Peter GRUBER, Wien (AT); Aleksandr OVSIANIKOV, Wien (AT)

(73) Assignee: TECHNISCHE UNIVERSITÄT WIEN, Vienna (AT)

(21) Appl. No.: 18/277,279

(22) PCT Filed: Feb. 16, 2022
(86) PCT No.: PCT/IB2022/051368

§ 371 Date: Aug. 15, 2023

(30) Foreign Application Priority Data
Feb. 16, 2021 (EP) 21020076.2

(51) Int. Cl. B29C 64/386; B29C 64/135

(52) U.S. Cl. CPC B29C 64/386; B29C 64/135; B33Y 50/00

(57) ABSTRACT

In a method of controlling a lithography-based additive manufacturing device capable of manufacturing a three-dimensional component from a plurality of volume elements, a check is made to determine whether the volume elements are entirely within the three-dimensional virtual model by identifying at least first and second boundary points of the volume element or virtual model in x-y planes spaced apart in the z-direction, and the volume element in question is provided for the manufacturing process only if it is within the model with respect to the first and second boundary points.

The invention relates to a method for controlling a lithography-based additive manufacturing device with which a three-dimensional component can be produced from a plurality of volume elements.

The invention further relates to a control apparatus for controlling a lithography-based additive manufacturing device with which a three-dimensional component can be produced from a plurality of volume elements.

In addition, the invention relates to an apparatus for the lithography-based generative production of a three-dimensional component, comprising a material support for a solidifiable material and an irradiation device which can be controlled for the position-selective irradiation of the solidifiable material with at least one beam, the irradiation device comprising an optical deflection unit in order to direct the at least one beam successively onto focal points within the material, whereby a respective volume element of the material located at the focal point is solidifiable by means of multiphoton absorption, and further comprising a control apparatus for controlling the irradiation device to build up the component from a plurality of solidified volume elements according to the three-dimensional virtual model of the component.

A process for forming a component in which the solidification of a photosensitive material is carried out by means of multiphoton absorption has become known, for example, from DE 10111422 A1. For this purpose, a focused laser beam is irradiated into the bath of the photosensitive material, whereby the irradiation conditions for a multiphoton absorption process triggering the solidification are only fulfilled in the immediate vicinity of the focus, so that the focus of the beam is guided to the points to be solidified within the bath volume according to the geometric data of the component to be produced.

At the respective focal point, a volume element of the material is solidified, whereby adjacent volume elements adhere to each other and the component is built up by successive solidification of adjacent volume elements. When building up the component, it is possible to proceed in layers, i.e. volume elements of a first layer are first solidified before volume elements of a next layer are solidified.

Irradiation devices for multiphoton absorption methods include an optical system for focusing a laser beam and a deflection device for deflecting the laser beam. In this case, the deflection device is designed to focus the beam successively on focal points within the material that lie essentially in one and the same plane perpendicular to the direction in which the beam enters the material. In an x,y,z coordinate system, this plane is also called the x,y plane. The solidified volume elements created by the beam deflection in the x,y plane form a layer of the component.

To build up the next layer, the relative position of the irradiation device relative to the component is changed in the z-direction, which corresponds to a direction of irradiation of the at least one beam into the material and is perpendicular to the x,y-plane. Due to the mostly motor-driven adjustment of the irradiation device relative to the component, the focal point of the irradiation device is displaced to a new x,y plane, which is spaced in the z direction from the preceding x,y plane by the desired layer thickness.

The starting point for manufacturing a component using an additive manufacturing process or 3D printing process is a three-dimensional virtual model of the component to be manufactured. The virtual model is usually created using CAD software. From the virtual model, control data must subsequently be generated that contain specific instructions to the additive manufacturing device, causing it to produce the desired component from solidified volume elements. The control instructions include instructions to the exposure unit including the deflection unit, to an adjusting means for adjusting the material support relative to the irradiation device, and to a material feed unit. In view of the layered structure of the component, so-called slicing software is used for this purpose, which converts the three-dimensional virtual model of the component into a stack of flat layers. Each layer has a specific geometry corresponding to the respective cross-section of the component, which the additive manufacturing device is to assemble from a plurality of volume elements.

The volume elements can be arranged in a grid-like manner, for example, so that only those volume elements that are located within the geometry may be solidified to achieve the respective desired geometry. To determine which volume elements are inside or outside the desired geometry, conventional methods usually use only the position of the center point (mathematical point) of the volume element resulting from the grid. This means that volume elements are provided for solidification, the center of which is located within the desired geometry. Since the volume element has a spatial extension beyond the mathematical center point, this leads to the production of volume elements in edge areas that protrude beyond the boundary of the desired geometry. The manufactured component may therefore have larger dimensions than those of the virtual model. In the case of components with internal cavities, such as channels, this can also lead to them being produced with dimensions that are too small or being overgrown at all.

Previous attempts to take into account the complete spatial extent of the volume elements when selecting the volume elements to be solidified were very computationally intensive because, for example, all triangles of a surface of the virtual model approximated by a mesh of triangles have to be iterated through on the basis of the “cusp height” in order to calculate the distance by which a volume element has to be displaced.

The invention therefore aims at providing a method and a device with which components can be produced without excessive computational effort, the volume elements of which do not protrude beyond the boundary surfaces of the component specified by the virtual model, if possible.

To solve this problem, the invention provides a method for controlling a lithography-based additive manufacturing device capable of producing a three-dimensional component from a plurality of volume elements, comprising the following steps:
a) providing a three-dimensional virtual model of the component in a virtual three-dimensional space with a coordinate system comprising an x-, y- and z-axis,
b) dividing the virtual space into a plurality of virtual volume elements, each volume element having an extent in the x-y plane and a height in the z-direction extending from a coordinate z1 to a coordinate z2,
c) verifying that a volume element is completely within the three-dimensional virtual model, comprising:
   i) identifying first boundary points of the volume element or the virtual model having the z1 coordinate and identifying second boundary points of the volume element or the virtual model having the z2 coordinate,
   (ii) checking that the first boundary points of the volume element are within the virtual model or that the volume element is entirely within the first boundary points of the virtual model; and
   iii) checking whether the second boundary points of the volume element are inside the virtual model or whether the volume element is completely inside the second boundary points of the virtual model,
d) only if at least ii) and iii) have been positively tested: marking the volume element as a volume element to be manufactured,
e) repeating steps (c) and (d) for a plurality of volume elements,
f) transmitting control data to the manufacturing device which are suitable for effecting the manufacture of the volume elements to be manufactured.

Thus, the decision on whether or not to produce or print a particular volume element is based on consideration of at least two planes spaced apart in the height direction of the volume element, at the bottom of the volume element (z1 coordinate) and at the top of the volume element (z2 coordinate). For each plane, it is checked whether boundary points of the volume element are outside or inside the boundary surface of the virtual model, and the volume element is printed only if the boundary points are inside the model in both cross sections. Alternatively, for each plane, a check is made to see if the volume element in the plane under consideration is entirely within the boundary points of the volume element, and the volume element is printed only if the volume element is within the model in all planes under consideration.

The assumption is that a volume element that does not protrude above the model in the two planes mentioned does not protrude above the model's boundary surfaces in the planes in between. This assumption is justified for a large part of the model shapes.

However, in special cases, such as inwardly curved external contours or internal cavities, it is preferred to include at least one additional plane and to print a volume element only if boundary points of the volume element in all three or more planes do not project beyond the respective cross-section of the model.

In this regard, a preferred embodiment of the method according to the invention provides that step c) further comprises:
iv) identifying third boundary points of the volume element or virtual model having a z3 coordinate, the z3 coordinate being between the z1 and z2 coordinates,
v) checking if the third boundary points of the volume element are within the virtual model or if the volume element is entirely within the third boundary points of the virtual model,
   wherein the volume element in step d) is marked as a volume element to be manufactured only if at least ii) and iii) and v) are tested positively.

If a third plane is used, it is advantageous to place it in the middle between the top and bottom planes. The z3 coordinate is then in the middle between the lowest plane (z1 coordinate) and the highest plane (z2 coordinate).

The first, second, and third boundary points, respectively, can be identified in several ways. The boundary points can be isolated, discrete points on the perimeter of the volume element or virtual model respectively. Alternatively, the points together may form the entire perimeter of the volume element or virtual model, respectively, that lies in the respective plane, i.e., the boundary points may merge to form an boundary line. The boundary line corresponds to the edge of a section that lies in that plane which is in the z1, z2 or z3 coordinate.

For the creation of the slices, the cross-section of a body with a plane of a slicing software can be used, so that separate operations and the associated computational effort can be omitted.

Preferred embodiments of the invention therefore provide that the first boundary points of the volume element are identified by creating a first cross-section of the virtual model in an x-y plane with the z1 coordinate of the volume element, that the second boundary points of the volume element are identified by creating a second cross-section of the virtual model in an x-y plane with the z2 coordinate of the volume element, and in that the third boundary points of the volume element are identified by creating a third cross-section of the virtual model in an x-y plane with the z3 coordinate of the volume element. In this case, checking whether a volume element is completely within the three-dimensional virtual model preferably comprises the step of checking whether the respective section of the volume element is completely within the corresponding cross-section of the virtual model.

An alternative embodiment of the invention provides that the first boundary points of the virtual model are identified by creating a first cross-section of the virtual model in an x-y plane with the z1 coordinate of the volume element, that the second boundary points of the virtual model are identified by creating a second cross-section of the virtual model in an x-y plane with the z2 coordinate of the volume element, and that the third boundary points of the virtual model are identified by creating a third cross-section of the virtual model in an x-y plane with the z3 coordinate of the volume element. In this case, checking whether a volume element is completely inside the three-dimensional virtual model preferably includes the step of checking whether the volume element is completely inside the mentioned sections of the virtual model in the respective planes.

The check whether a volume element in a z1 plane, a z2 plane and possibly other planes in between is entirely within the three-dimensional virtual model can also be performed in such a way that sections of the virtual model in the z1 plane, in the z2 plane and possibly in planes in between are made and the average of the sections (Boolean AND operation) is determined in the z projection direction and it is checked whether the volume element is entirely within the average. Here, it is assumed that the volume element has a constant cross-section over its z-extension. If this is not the case, e.g. in the case of a volume element in the shape of an ellipsoid, the boundary line of the average of the sections is moved inward by the amount by which the cross-section of the volume element varies over the z-extension, and the average area thus adjusted is used to check whether the volume element lies entirely within the average.

The check whether a volume element in a z1-plane, a z2-plane and possibly other planes in between is entirely within the three-dimensional virtual model can alternatively be carried out in such a way that a section of the virtual model is created in a z1-plane, then it is checked whether the volume element in this plane is located entirely within the section of the virtual model, and then it is checked whether projections, running in the z direction, of boundary points of the volume element determined in the z1 plane have at least one intersection point with the outline of the virtual model located within the z1-z2 extension of the volume element. If there is at least one intersection point, this means that the volume element is not completely within the virtual model over its entire z extension, so that this volume element is not marked as a volume element to be manufactured or printed.

When reference is made in the context of the invention to a coordinate system comprising an x-axis, a y-axis, and a z-axis, this may include various types of coordinate systems.

In particular, this may be a rectilinear coordinate system. However, the rectilinear coordinate system need not be an orthogonal coordinate system, but also includes designs in which the x-y plane and the z-axis enclose an angle not equal to 90°. Preferably, however, it is a Cartesian coordinate system.

The direction of the z-axis preferably corresponds to the irradiation direction of the irradiation device, i.e. the direction in which the light beams are directed to focal points within the material.

Step b) of the method provides for dividing the virtual space in which the virtual model is located into a plurality of virtual volume elements, and steps c) and d) subsequently provide for checking, at least for some of these volume elements, whether they are located within the virtual model. The volume elements distributed in the virtual space can be in different spatial arrangements. For example, the volume elements may be arranged in a predetermined grid, such as a three-dimensional grid in which the volume elements are arranged along a plurality of respective parallel lines extending in the x, y, and z directions of a rectangular spatial coordinate system.

Further, the volume elements may be arranged to overlap each other or to not overlap each other. For example, the volume elements may be provided to overlap each other in one portion of the model and to be non-overlapping in another portion. Alternatively, the volume elements can be arranged in an overlapping manner throughout the model.

The degree of overlap does not have to be uniform, but can be chosen depending on the local geometry of the model. For example, a higher degree of overlap may be selected at the edge of the model than inside the model. This can increase the resolution of the printing process in the edge areas as well as the geometric fidelity or reduce the surface roughness.

The virtual volume elements can all have the same volume, or virtual volume elements can be used within the same virtual model that have different volumes from each other.

According to step e), the verification of whether a volume element is entirely within the three-dimensional virtual model is repeated for a plurality of volume elements. It is possible to proceed in such a way that this check is performed for all volume elements of the virtual model, e.g. for all volume elements that are not completely outside the model from the outset. Alternatively, the check can be performed for only a subset of the volume elements, preferably for those volume elements which are located in the boundary region, i.e. along the boundary surface of the model.

The problem underlying the invention is also solved by a control apparatus comprising a computing device which comprises:
an electronic memory for storing a three-dimensional virtual model of the component in a virtual three-dimensional space having a coordinate system comprising an x-, y- and z-axis,
model processing means to which the virtual model of the component is fed and in which the virtual space of the virtual model is divided into a plurality of virtual volume elements, each volume element having an extension in the x-y plane and a height in the z-direction extending from a coordinate z1 to a coordinate z2,
wherein the model processing means are adapted to
i) identify third boundary points of the volume element or the virtual model having a z1 coordinate and identifying third boundary points of the volume element or the virtual model having a z2 coordinate,
ii) check whether the first boundary points of the volume element are within the virtual model or whether the volume element is entirely within the first boundary points of the virtual model; and
iii) check whether the second boundary points of the volume element are inside the virtual model or whether the volume element is entirely within the second boundary points of the virtual model,
wherein the model processing means comprises a logic module configured to pre-select the volume element as a volume element to be manufactured only upon positive testing of at least ii) and iii),
coding means for generating control data comprising control instructions for additive manufacturing of the volume elements to be manufactured,
data transmission means for transmitting the control data to the manufacturing device.

Preferably, it is provided that the model processing means are designed to
iv) identify third boundary points of the volume element or virtual model having a z3 coordinate, the z3 coordinate being between the z1 and z2 coordinates, and
v) check if the third boundary points of the volume element are within the virtual model or if the volume element is entirely within the third boundary points of the virtual model,
   and in that the logic module is designed to mark the volume element as a volume element to be manufactured only if at least ii) and iii) and v) are tested positively.

Another aspect of the invention relates to an apparatus for the lithography-based generative production of a three-dimensional component, comprising a material support for a solidifiable material and an irradiation device which can be controlled for the position-selective irradiation of the solidifiable material with at least one beam, the irradiation device comprising an optical deflection unit in order to focus the at least one beam successively onto focal points within the material, whereby a respective volume element of the material located at the focal point is solidifiable by means of multiphoton absorption, and further comprising a control apparatus for controlling the irradiation device to build up the component from a plurality of solidified volume elements according to the three-dimensional virtual model of the component.

Preferably, the irradiation device is designed to build up the component layer by layer with layers extending in the x-y plane, and an adjusting means is provided for adjusting the material support relative to the irradiation device in the z-direction so that the change from one layer to a next layer is effected by the adjusting means.

Preferably, the irradiation device comprises a laser light source and the deflection unit is designed to scan the solidifiable material within a writing area. The light beam is deflected in the x- or y-direction or in both directions. The deflection unit can be designed as a galvanometer scanner, for example. For two-dimensional beam deflection, either one mirror can be deflected in two directions or by means of three or more mirrors as a single pivot point scanner. Alternatively, two orthogonally rotatable standing mirrors are placed close to each other or connected by means of relay optics via which the beam is reflected. The two mirrors can each be driven by a galvanometer drive or electric motor.

A preferred design of the device provides that the material is present on a material support, such as in a trough, and the irradiation of the material is carried out from below through the material support, which is permeable to the radiation at least in certain areas. In this case, a build platform can be positioned at a distance from the material support and the component can be built up on the build platform by solidifying material located between the build platform and the material support. Alternatively, it is also possible to irradiate the material from above.

Structuring a suitable material using multiphoton absorption offers the advantage of exceedingly high structure resolution, with volume elements with minimum structure sizes of up to 50 nm×50 nm×50 nm achievable. Due to the small focal point volume, however, the throughput of such a method is very low, since, for example, for a volume of 1 mm³ with a voxel volume of 1 μm³, a total of more than 10⁹ points must be exposed. This leads to very long build times, which is the main reason for the low industrial use of multiphoton lithography processes.

In order to increase the component throughput without losing the possibility of high structure resolution, a preferred further development of the invention provides that the volume of the focal point is varied at least once during the build-up of the component, so that the component is built up from solidified volume elements of different volumes.

Due to the variable volume of the focal points, high resolutions are possible (with a small focal point volume). At the same time, a high writing speed (measured in mm³/h) is achievable (with a large focal point volume). Thus, by varying the focal point volume, high resolution can be combined with high throughput. The variation of the focal point volume can be used, for example, in such a way that a large focal point volume is used in the interior of the component to be built up in order to increase the throughput, and a smaller focal point volume is used on the surface of the component in order to form the component surface with high resolution. Increasing the focal point volume allows for higher structuring throughput by increasing the volume of material solidified in one exposure. To maintain high resolution at high throughput, small focal point volumes can be used for finer structures and surfaces, and larger focal point volumes can be used for coarse structures and/or to fill interior spaces. Methods and devices for changing the focal point volume are described in WO 2018/006108 A1.

Accordingly, the virtual volume elements arranged in the virtual space of the model can have different volumes. For example, the virtual volume elements inside the virtual model of the component may have a larger volume than the virtual volume elements located on the surface of the virtual model.

The principle of multiphoton absorption is used in the context of the invention to initiate a photochemical process in the photosensitive material bath. Multiphoton absorption methods include, for example, 2-photon absorption methods. As a result of the photochemical reaction, there is a change in the material to at least one other state, typically resulting in solidification or photopolymerization. The principle of multiphoton absorption is based on the fact that the aforementioned photochemical process takes place only in those areas of the beam path where there is sufficient photon density for multiphoton absorption. The highest photon density occurs at the focal point of the optical imaging system, so multiphoton absorption is sufficiently likely to occur only at the focal point. Outside the focal point, the photon density is lower, so the probability of multiphoton absorption outside the focal point is too low to cause an irreversible change in the material by a photochemical reaction. The electromagnetic radiation can pass through the material largely unhindered in the wavelength used, and only at the focal point does an interaction occur between photosensitive material and electromagnetic radiation. The principle of multiphoton absorption is described, for example, in Zipfel et al, “Nonlinear magic: multiphoton microscopy in the biosciences,” NATURE BIOTECHNOLOGY VOLUME 21 NUMBER 11 Nov. 2003.

The source of the electromagnetic radiation may preferably be a collimated laser beam. The laser can emit one or more, fixed or variable wavelengths. In particular, it is a continuous or pulsed laser with pulse lengths in the nanosecond, picosecond or femtosecond range. A pulsed femtosecond laser offers the advantage that a lower average power is required for multiphoton absorption.

Photosensitive material is defined as any material that is flowable or solid under building conditions and that changes to a second state by multiphoton absorption in the focal point volume—for example, by polymerization. The material change must be limited to the focal point volume and its immediate surroundings. The change in substance properties may be permanent and consist, for example, in a change from a liquid to a solid state, but it may also be temporary. Incidentally, a permanent change may also be reversible or non-reversible. The change in the material properties does not necessarily have to pass completely from one state to the other, but can also be a mixed form of both states.

The invention is explained in more detail below with reference to exemplary embodiments shown schematically in the drawing. Therein,

FIG. 1 shows a schematic representation of a device according to the invention and

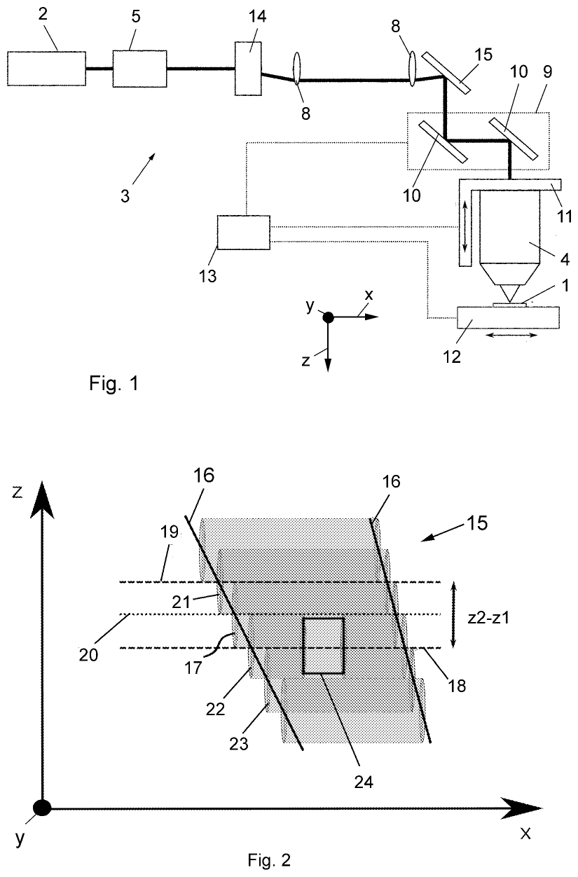

FIG. 2 to FIG. 4 show schematic representations of a virtual model of a component with volume elements.

In FIG. 1, a substrate or carrier is denoted with 1, on which a component is to be built. The substrate is arranged in a material vat, not shown, which is filled with a photopolymerizable material. A laser beam emitted from a radiation source 2 is successively focused into the material by an irradiation device 3 at focal points within the photopolymerizable material, thereby solidifying a volume element of the material located at each focal point by multiphoton absorption. For this purpose, the irradiation device includes an imaging unit comprising a lens 4 that introduces the laser beam into the material within a writing area.

The laser beam first enters a pulse compressor 5 from the radiation source 2 and is then guided via a modulator of the laser power (e.g.: an acousto-optical modulator) 14, relay lenses 8 and a deflection mirror 15 into a deflection unit 9, in which the beam is successively reflected at two mirrors 10. The mirrors 10 are driven to pivot about axes of rotation, preferably orthogonal to each other, so that the beam can be deflected in both the x- and y-axes. The two mirrors 10 can each be driven by a galvanometer drive or electric motor. The beam exiting the deflection unit 9 preferably enters the objective via a relay lens system, not shown, which focuses the beam into the photopolymerizable material as mentioned above.

To build up the component layer by layer, volume elements of one layer after the other are solidified in the material. To build up a first layer, the laser beam is successively focused on focal points located in the focal plane of the objective 4 within the material. The deflection of the beam in the x,y plane is performed here with the aid of the deflection unit 9, whereby the writing area is limited by the objective 4. For the change to the next plane, the objective 4 attached to a carrier 11 is displaced in the z-direction relative to the substrate 1 by the layer distance, which corresponds to the layer thickness. Alternatively, the substrate 1 can be displaced relative to the fixed objective 4.

If the component to be produced is larger in the x and/or y direction than the writing area of the objective 4, partial structures of the component are built up next to each other (so-called stitching). For this purpose, the substrate 1 is arranged on a cross table 12, which can be moved in the x and/or y direction relative to the irradiation device 3.

Furthermore, a control 13 is provided which controls the radiation source, the deflection device 9, the support 11 and the cross table 12.

FIG. 2 schematically shows a coordinate system comprising an x-, y- and z-axis. A section of a virtual model 15 of a component to be manufactured is arranged in the coordinate system, the virtual model 15 being bounded in the x-z plane by the lines 16. A channel 24 is provided inside the virtual model 15 to remain free of solidified material. A plurality of virtual volume elements 17, 21, 22, 23, etc., are arranged in the virtual space, wherein it is shown from the virtual volume elements 17 that they have a height (z2−z1) extending from a coordinate z1 to a coordinate z2 in the z-direction. The volume elements 17 thus extend in the height direction between an x-y plane 18 lying at the z1 coordinate and an x-y plane 19 lying at the z2 coordinate. The center plane of the volume elements 17 is designated 20. In the example shown here, the volume elements are arranged in a plurality of planes spaced apart in the z-direction. Above and below the volume elements 17 there are further levels of volume elements 21, 22, 23 etc., whereby the volume elements of adjacent planes can overlap. A large number of volume elements are arranged within the individual planes, of which only the edge-side volume elements are clearly shown in each case in FIG. 2, where the shape of an ellipsoid of revolution can be seen.

FIG. 2 shows a prior art method for determining, in the boundary region of the virtual model 15, which of the virtual volume elements are marked as volume elements to be manufactured and subsequently actually printed using an additive manufacturing device, i.e. a 3D printer. In the method according to FIG. 2, only the center plane 20 or the center of the volume elements is considered and it is checked whether the volume element in the center plane is inside or outside the virtual model 15 or whether the center of the volume element is inside or outside the virtual model 15. Because the actual spatial extent of the volume elements extends beyond the center plane, this results in volume elements being marked for printing that extend beyond the outline of the virtual model, as shown in FIG. 2. Furthermore, this leads to the printing of volume elements that cause channel 24 to overgrow.

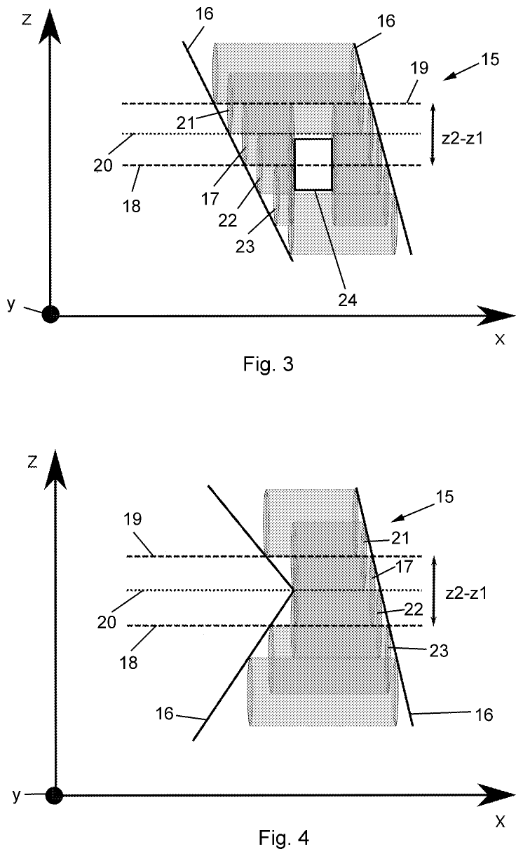

In the method according to the invention as shown in FIG. 3, on the other hand, it is not checked in the center plane 20, but both in the uppermost plane 19 (coordinate z2) and in the lowermost plane 18 (coordinate z1) whether the volume elements 17 lie within the boundaries 16 of the virtual model 15. A volume element is marked for printing only if it is located in both the top layer 19 and the bottom layer 18 within the virtual model 15. As a result, in the geometry of the virtual model 15 shown in FIG. 3, none of the volume elements protrude beyond the outline of the model 15 and the channel remains completely free.

In the geometry of the virtual model 15 shown in FIG. 4, where the left boundary 16 has an inward bend, the center plane 20 must be considered in addition to the top plane 19 and the bottom plane 18. Thus, only those volume elements are marked for printing which are located in the top plane 19 as well as in the bottom plane 18 and in the middle plane 20 within the virtual model 15. As a result, none of the volume elements protrude beyond the outline of model 15 in the area of the kink either.

1. A method of controlling a lithography-based additive manufacturing device capable of producing a three-dimensional component from a plurality of volume elements, comprising the following steps:
a) providing a three-dimensional virtual model of the component in a virtual three-dimensional space with a coordinate system comprising an x-, y- and z-axis,
b) dividing the virtual space into a plurality of virtual volume elements, each volume element having an extent in the x-y plane and a height in the z-direction extending from a coordinate z1 to a coordinate z2,
c) verifying that a volume element is completely within the three-dimensional virtual model, comprising:
i) identifying first boundary points of the volume element or the virtual model having the z1 coordinate and identifying second boundary points of the volume element or the virtual model having the z2 coordinate,
ii) checking whether the first boundary points of the volume element are located within the virtual model or whether the volume element is located entirely within the first boundary points of the virtual model in the plane having the z1 coordinate, and
iii) checking whether the second boundary points of the volume element are located within the virtual model or whether the volume element is located entirely within the second boundary points of the virtual model in the plane having the z2 coordinate,
d) only if at least ii) and iii) have been positively tested: marking the volume element as a volume element to be manufactured,
e) repeating steps (c) and (d) for a plurality of volume elements,
f) transmitting control data to the manufacturing device which are suitable for effecting the manufacture of the volume elements to be manufactured.

2. The method of claim 1, characterized in that step c) further comprises:
iv) identifying third boundary points of the volume element or virtual model having a z3 coordinate, the z3 coordinate being between the z1 and z2 coordinates,
v) checking whether the third boundary points of the volume element are inside the virtual model or whether the volume element is entirely within the third boundary points of the virtual model in the plane containing the z3 coordinate,
and in that the volume element in step d) is marked as a volume element to be manufactured only if at least ii) and iii) and v) are tested positively.

3. The method of claim 2, characterized in that the z3 coordinate is located in the middle between the z1 and the z2 coordinate.

4. The method of claim 1, characterized in that the first boundary points are identified by creating a first cross-section of the virtual model in an x-y plane with the z1 coordinate of the volume element.

5. The method of claim 1, characterized in that the second boundary points are identified by creating a second cross-section of the virtual model in an x-y plane with the z2 coordinate of the volume element.

6. The method of claim 2, characterized in that the third boundary points are identified by creating a third cross-section of the virtual model in an x-y plane with the z3 coordinate of the volume element.

7. The method of claim 1, characterized in that the volume elements have the shape of a cuboid or an ellipsoid, in particular an ellipsoid of revolution.

8. A control apparatus for controlling a lithography-based additive manufacturing device capable of producing a three-dimensional component from a plurality of volume elements, comprising a computing device which comprises:
an electronic memory for storing a three-dimensional virtual model of the component in a virtual three-dimensional space having a coordinate system comprising an x-, y- and z-axis,
model processing means to which the virtual model of the component is fed and in which the virtual space of the virtual model is divided into a plurality of virtual volume elements, each volume element having an extension in the x-y plane and a height in the z-direction extending from a coordinate z1 to a coordinate z2,
wherein the model processing means are adapted to
i) identify third boundary points of the volume element or the virtual model having a z1 coordinate and identifying third boundary points of the volume element or the virtual model having a z2 coordinate,
ii) check whether the first boundary points of the volume element are located within the first cross-section of the virtual model or whether the volume element is located entirely within the first boundary points of the virtual model in the plane having the z1 coordinate, and
iii) check whether the second boundary points of the volume element are located within the second cross-section of the virtual model or whether the volume element is located completely within the second boundary points of the virtual model in the plane having the z2 coordinate,
wherein the model processing means comprises a logic module configured to pre-select the volume element as a volume element to be manufactured only upon positive testing of at least ii) and iii),
coding means for generating control data comprising control instructions for additive manufacturing of the volume elements to be manufactured,
data transmission means for transmitting the control data to the manufacturing device.

9. The control apparatus of claim 8, characterized in that the model processing means are adapted to
iv) identify third boundary points of the volume element or virtual model having a z3 coordinate, the z3 coordinate being between the z1 and z2 coordinates, and
v) check whether the third boundary points of the volume element are located within the third cross-section of the virtual model or whether the volume element is located entirely within the third boundary points of the virtual model in the plane having the z3 coordinate, and in that the logic module is designed to mark the volume element as a volume element to be manufactured only if at least ii) and iii) and v) are tested positively.

10. The control apparatus of claim 9, characterized in that the z3 coordinate is located in the middle between the z1 and z2 coordinates.

11. An apparatus for the lithography-based generative production of a three-dimensional component, comprising a material support for a solidifiable material and an irradiation device which can be controlled for the position-selective irradiation of the solidifiable material with at least one beam, the irradiation device comprising an optical deflection unit in order to focus the at least one beam successively onto focal points within the material, whereby a respective volume element of the material located at the focal point is solidifiable by means of multiphoton absorption, and further comprising a control apparatus according to claim 8 for controlling the irradiation device to build up the component from a plurality of solidified volume elements according to the three-dimensional virtual model of the component.

12. The apparatus of claim 11, characterized in that the irradiation device is adapted to build up the component layer by layer with layers extending in the x-y plane, and in that an adjusting means is provided for adjusting the material support relative to the irradiation device in the z-direction so that the change from one layer to a next layer is effected by the adjusting means.

13. The apparatus of claim 11, characterized in that the irradiation device comprises a laser light source and the deflection unit is designed for line-by-line scanning of the solidifiable material.
